(19) United States
(12) Patent Application Publication
(10) Pub. No.: US 2003/0149618 A1
(43) Pub. Date: Aug. 7, 2003

(54) Flexible dynamic advertising

(75) Inventors: Ilan S. Sender, Bellevue, WA (US); William Manis, Sammamish, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/060,318

(22) Filed: Feb. 1, 2002

(51) Int. Cl. G06F 17/60

(52) U.S. Cl. 705/14; 705/26

(57) ABSTRACT

Various systems and methods allow advertising content in products to be more flexible and dynamic. One feature allows the product purchaser to control the amount or type of advertising he or she receives along with a product. By paying a higher, premium fee, the user may receive a version of the product that contains little or no advertisement. However, if the user would like to receive advertisements with the product, a less expensive version is available that additionally includes advertisement content. Another feature of the invention allows advertisers to bid for advertisement slots provided in product packages. The products and advertisements may be structured so that the advertiser may freely change or manipulate the advertisements at any time.

### FIELD OF THE INVENTION

This invention relates to systems and methods that make advertising more flexible, dynamic, and personalized.

### BACKGROUND

Currently, advertising comes in many different flavors. It may completely subsidize the product content (e.g., network television), or it may partially subsidize the product content (e.g., magazines or newspapers). Moreover, advertisement content may be displayed concurrently with the product content (e.g., magazine ads, banner type ads on the internet, etc.) or sequentially with the product content (e.g., television or radio commercials).

Presently, product package suppliers determine most features of the advertisement content in any given product package (a “product package” includes product content and optionally advertisement content). For example, the product package supplier determines: (a) the number of advertisements, (b) the length or volume of the advertisement content, and (c) the parties who will be allowed to present advertisements. While the advertiser may control the content of the advertisements, in most instances, once the advertisement content is sent to the product package supplier, the advertisement content is fixed for the product package. The product purchaser has little to no say in the advertisement content.

This “one size fits all” style of presenting advertisement content does not effectively serve the parties involved. For example, some users of products and services strongly dislike advertisement interruption when using the products or services. On the other hand, some people do not mind (and, in fact, may enjoy) a periodic commercial interruption. Furthermore, the end user typically has no control over the products or services for which he or she receives advertisements.

Advertisers also are not well served by the present “one size fits all” advertising, at least not in all situations. For example, advertisers may know very little about the ultimate end user who will “consume” their advertisement content in a given product package. Because the advertiser may not be able to readily ascertain who will receive their advertisements along with a given product package, the advertiser may not know whether this ad receiver is a good candidate for purchasing the goods or services advertised. For these reasons, the advertiser may not believe that she is getting good value from her advertising dollar. A potential advertiser would likely pay a higher price to place advertisement content if the advertiser knew that the advertisement was likely to be received by an interested and receptive end user.

Because of the shortcomings in filling the needs of the ultimate customers and advertisers, present advertising systems also are not optimal for the product package provider. If the end users receive more advertisement content than they desire or if they receive advertisement content directed to products or services of no interest to them, this may result in an unhappy end customer. Also, if the advertiser cannot adequately target ads to the ultimate user, then the advertiser may not be willing to pay as much for placing an advertisement. This results in reduced revenue for the product package provider.

In order to make advertising more effective for the advertisers, more profitable for the product package provider, and more enjoyable to the end user of the product package, it would be advantageous to make advertising more flexible, dynamic, and personalized.

### SUMMARY

In general, this invention relates to systems and methods for making advertising more flexible, dynamic, and personalized. Flexible, dynamic, and personalized advertising may be accomplished in many ways. For example, the systems and methods according to the invention may allow the product or service purchaser to control the amount and/or type of advertising he or she receives with the product or service package. Also, in some examples of systems and methods according to the invention, the advertiser may freely change the final advertisement content at any time until the advertisement content is sent to, downloaded by, and/or actually consumed by the purchaser. Additionally, in some examples of the invention, a bidding system may be used to match advertisers and product content providers. Some examples of the invention also allow the ultimate product content to be changed to include advertisement content that identifies products or services of the advertisers (i.e., advertiser's “product placement” in the product content).

### BRIEF DESCRIPTION OF THE DRAWINGS

The foregoing Summary, as well as the following Detailed Description, will be better understood when read in conjunction with the accompanying drawings, which are included by way of example, and not by way of limitation with regard to the claimed invention.

FIG. 1 illustrates an example of a user interface information display that allows a user to define or select from a plurality of predefined product packages in accordance with embodiments of the present invention;

FIGS. 2a and 2b illustrate examples of a user interface information display for selecting a product package using a “slider bar” continuum in accordance with embodiments of the present invention;

FIGS. 3a and 3b are flow diagrams illustrating examples of product and advertisement content delivery for two different product packages, e.g., for delivery of song or video products, in accordance with embodiments of the present invention;

FIGS. 4a through 4c illustrate examples of product and advertisement content delivery for three different product packages, e.g., for delivery of an e-book, e-magazine, or e-newspaper, in accordance with embodiments of the present invention;

FIG. 5 illustrates one example of potential participants in methods according to embodiments of the invention;

FIG. 6 illustrates one example of potential participants and potential hardware useful in methods and systems according to embodiments of the invention;

FIG. 7 illustrates an example of a user interface information display that allows the user to select the type of advertisement content he or she desires with a product package in accordance with embodiments of the present invention;

FIG. 8 illustrates a schematic diagram of a general-purpose digital computing environment that may be used to implement various aspects of the invention; and

FIG. 9 illustrates a plan view of a tablet computer system and user input device that may be used in accordance with embodiments of the present invention.

### DETAILED DESCRIPTION

As described above, this invention relates to systems and methods that make advertising more flexible, dynamic, and personalized. In some examples, these systems and methods allow the product or service purchaser to control the amount and/or type of advertising he or she receives with the product or service. Also, in some examples, the producer of the advertisement content may freely change the final advertisement content at any time until the advertisement content is actually downloaded by, delivered to, and/or consumed by the purchaser or user. Additionally, in some examples of the invention, a bidding system may be used to match advertisers and content providers, optionally in light of the amount and/or type of advertisement content desired and selected by the product purchaser. Additional examples of the invention allow the product content to be changed to include advertisement content from advertisers (i.e., “product placement” in the product content). Ad slots may be structured such that each time the ad slot is viewed, it may contain different advertisement content, optionally from different advertisers.

Terms

As used in this specification, the term “price” may include products or services transferred in exchange for payment or for free, provided that for free products or services, the user selects a product package or product option actually having some advertisements. Likewise, the term “advertisement content” additionally may include products or services having no actual advertisements, provided the user selects a higher priced or “premium” product package or product option.

Also, as used in this specification, the term “product” is used generically to refer to any type of product or service offered to purchasers or users. Illustrative examples of suitable products or services that may be sold or otherwise made available using the methods and systems according to this invention include: videos (on-line and off-line, e.g., video cassettes or DVDs); movies (on-line and off-line); music (on-line and off-line, e.g., tapes or CDs); software (on-line and off-line, e.g., via disks); e-books; e-magazines, etc.

The terms “user” and “purchaser” in this specification are used generically and interchangeably. These terms generally refer to any person or persons that: (a) interact with the systems and methods according to the invention to obtain or order a product, (b) receive a product as a result of interaction by someone with the systems and methods according to the invention, and/or (c) use a product obtained as a result of interaction by someone with the systems and methods according to the invention. A “user” of a product or an interface provided by the invention need not be the same person that pays for a product. Moreover, a “purchaser” of a product may simply order a product, and not necessarily pay for it (e.g., in the event that a product option is selected wherein the product is free or is paid for by another). Additionally, a “purchaser” of a product may not ultimately use the product, e.g., if the product is obtained for delivery to or use by another.

In general, a “product package” or “product,” as used herein, includes a product content and optionally an advertisement content (if any is ordered by the user). “Advertisement content” refers to the overall advertisements presented in a product package. For example, if two product packages contain a different overall number of advertisements or if one product package contains at least one advertisement that differs from the advertisements contained in the other product package, then these product packages have different “advertisement content.” In general, product packages included in the same offer for sale include the same or substantially the same “product content.” For example, if the product content between two product packages changes in a minor way to accommodate “product placement” type advertisements, or if the product content between two product packages changes in a minor way to accommodate insertion of the advertisement content, the two product packages still are considered to contain the same “product content.”

General Purpose Computer

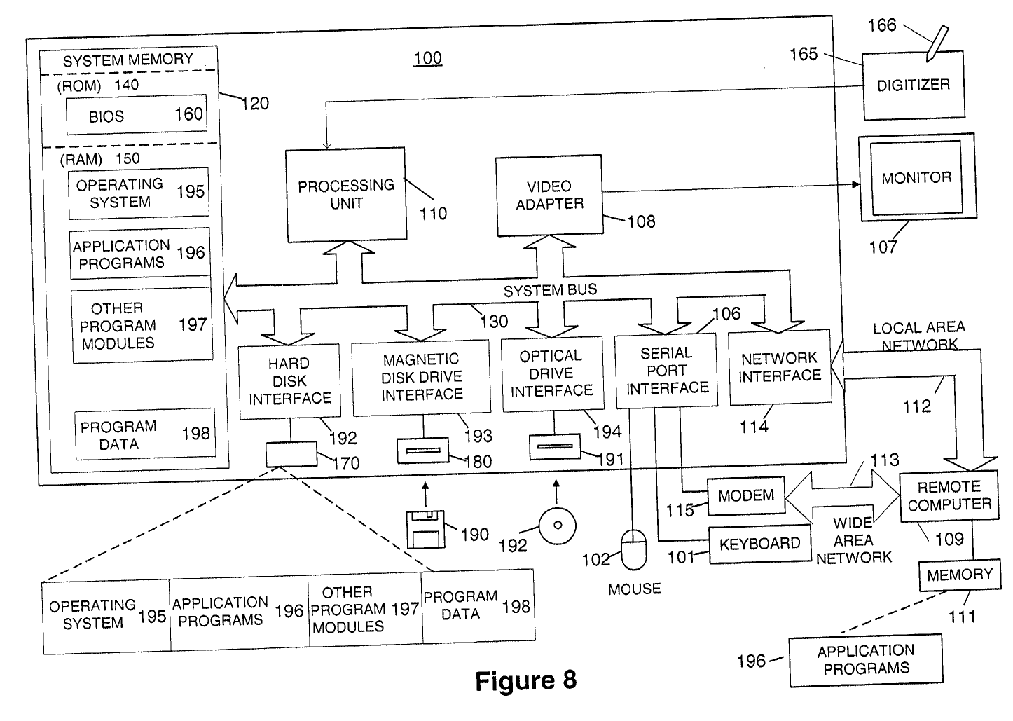

FIG. 8 illustrates a schematic diagram of an exemplary conventional general-purpose digital computing environment that may be used to implement various aspects of the present invention. In FIG. 8, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192, such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules, and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules may be stored on the hard disk drive 170, magnetic disk 190, optical disk 192, ROM 140, or RAM 150, including an operating system 195, one or more application programs 196, other program modules 197, and program data 198. A user may enter commands and information into the computer 100 through input devices, such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus 130, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor 107, personal computers typically include other peripheral output devices (not shown), such as speakers and printers. In a preferred embodiment, a pen digitizer 165 and accompanying pen or stylus 166 are provided in order to digitally capture freehand input. Although a direct connection between the pen digitizer 165 and the processing unit 110 is shown, in practice, the pen digitizer 165 may be coupled to the processing unit 110 via a serial port, parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 may operate in a networked environment using logical connections to one or more remote computers, such as a remote computer 109. The remote computer 109 may be a server, a router, a network PC, a peer device or other common network node, and typically includes many or all of the elements described above relative to the computer 100, although only a memory storage device 111 has been illustrated in FIG. 8. The logical connections depicted in FIG. 8 include a local area network (LAN) 112 and a wide area network (WAN) 113. Such networking environments are commonplace in offices, enterprise-wide computer networks, intranets and the Internet.

When used in a LAN networking environment, the computer 100 is connected to the local area network 112 through a network interface or adapter 114. When used in a WAN networking environment, the personal computer 100 typically includes a modem 115 or other means for establishing a communications link over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other techniques for establishing a communications link between the computers may be used. The existence of any of various well-known protocols, such as TCP/IP, Ethernet, FTP, HTTP and the like, is presumed, and the system may be operated in a client-server configuration to permit a user to retrieve web pages from a web-based server. Any of various conventional web browsers may be used to display and manipulate data on web pages.

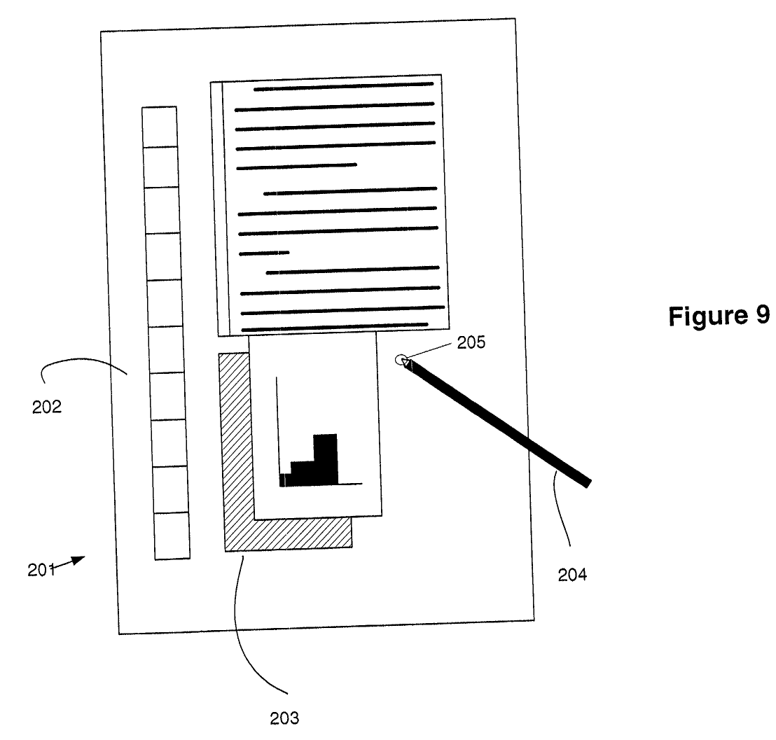

FIG. 9 illustrates an exemplary tablet PC 201 that may be used in accordance with various aspects of the present invention. Any or all of the features, subsystems, and functions in the system of FIG. 8 may be included in the computer of FIG. 9. Tablet PC 201 includes a large display surface 202, e.g., a digitizing flat panel display, such as a liquid crystal display (LCD) screen, on which a plurality of windows 203 is displayed. Using stylus 204, a user may select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, also may be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one example, the stylus 204 may be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like may be used. Additionally, a user's own finger may be the stylus 204 and used for selecting or indicating portions of the displayed image on a touch-sensitive or proximity-sensitive display. Consequently, the term “user input device,” as used herein, is intended to have a broad definition and encompasses many variations on well-known input devices such as stylus 204. Region 205 shows a feedback region or contact region permitting the user to determine where the stylus 204 has contacted the display surface 202.

Detailed Description

A. Systems and Methods Allowing the User to Influence Advertisement Content.

Several aspects of this invention stem from the idea that a user should be able to have at least some input into the amount or type of advertisement content they receive along with products or services. Some purchasers or users of products are very cost conscious, and they will take whatever steps are available to save money. Other purchasers or users simply do not mind or may enjoy advertisements included with products. Such purchasers or users may be willing to “consume” advertisement content, e.g., in order to save money on the purchase. Other purchasers or users do not desire being exposed to or inundated with advertisement content. Such purchasers or users may be willing to pay a higher price or “premium” to receive a product having little or no advertisement content. Offering this type of “flexibility” may help generate and maintain good relationships between product content providers, aggregators, and their customers.

One example of the invention relates to a method for allowing a product or service purchaser to control or influence the amount or type of advertising he or she receives along with a product. If the user does not mind receiving advertisements with a product or wants to save money, he or she may order a less expensive product package that also includes advertisement content. However, if the user does not wish to receive advertisement content along with the product, he or she may order a “premium” version of the product that includes either no advertisement content or a reduced amount of advertisement content.

In general, this exemplary method includes providing a user interface that enables a user to define a product package, wherein the product package includes product content and optionally advertisement content. This user interface may be an information display that allows the user to select an amount and/or type of advertisement content that he or she would like to be included in the product package. The user inputs information indicting the amount and/or type of advertisement content to be included, and the user is then charged for the product package ordered. The final price of the product package is determined, at least in part, based on the amount or type of advertisement content selected by the user (as noted above, the product package may be free, if advertisement is included). The desired product package may be delivered in a manner directed by the user, e.g., over a computer network system, by e-mail, by mail or other courier service, to another, etc.

Another example of the invention relates to a system for performing the above exemplary method. The system includes means for providing a user interface to a user that enables the user to define a product package including product content and optionally advertisement content and to select an amount and/or type of advertisement content to be included in the product package. The system according to this example of the invention also includes a means for receiving information input by the user through the user interface that indicates at least the amount or type of advertisement content to be included in the product package, and a means for charging (or billing) the user for the product package. Optionally, the system according to this example of the invention may further include a means for delivering the product package in a manner directed by the user (e.g., over a computer network system, via telephone lines, cable, e-mail, etc.).

Another example of the invention relates to a method for allowing a product purchaser to control the amount of advertising he or she receives along with a product package. This method includes: (a) defining a plurality of product packages including at least a first product package and a second product package, wherein the first product package includes at least a first product content and a first advertisement content, and wherein the second product package includes at least the first product content and optionally second advertisement content; (b) offering to sell the product packages to a user, wherein the first product package is offered to the user at a first price and the second product package is offered to the user at a second price that is different from the first price (as noted above, some product packages may be free); (c) receiving the user's selection of one of the product packages; and (d) delivering a final product package based on the user's selection. Any number of different product packages may be offered in this manner. For example, the offer may include a third product package at a third price, and this third product package may include an overall advertisement content different from that contained in the first and second product packages.

In this example of the invention, the product packages may be offered to the user such that the user selects a product package based on its payment price or its amount of advertisement content (both the payment price and the amount of advertisement content may be displayed to the user). The final price of the product package will depend, at least in part, on the amount of advertisement content contained in the package selected by the user. As one specific example, the product packages may be offered to the user as a listing of specific packages on the user interface information display. As another example, the product packages may be offered in the form of a continuum, wherein the first price and the first advertisement content are located at a first end of the continuum and the second price and the second advertisement content (or no advertisement content) are located at a second end of the continuum, wherein a price of the product package increases from the first end to the second end of the continuum and the amount of advertisement content in the product package decreases from the first end to the second end of the continuum. As yet another example, the user could simply enter into the interface the price they wish to pay or the advertisement volume they are willing to consume, and then the system will advise them of the parameters of the product package. The system may be set up so that users can change their input parameter before committing to the sale.

Another example of the invention relates to a system for performing the method described above. This system includes a means for offering a plurality of product packages for sale to a user, wherein the product packages include at least a first product package and a second product package as described above. The system further includes a means for receiving the user's selection of one of the product packages and a means for delivering this selected, final product package.

Another example of the invention also relates to a method for allowing a product or service purchaser to control the amount and/or type of advertising he or she receives along with a product package. In general, this method includes: (a) displaying a user interface information display that enables a user to define a product package, wherein the product package includes product content and optionally advertisement content, and wherein the user interface allows the user to select an amount and/or type of advertisement content to be included in the product package; (b) inputting information indicating the amount and/or type of advertisement content to be included in the product package; and (c) receiving the product package. As with previous examples, a final price of the product package is determined, at least in part, based on the amount and/or type of advertisement content selected by the user.

The invention also relates to a system for performing the method described immediately above. The system includes means for displaying the user interface and means for inputting information through the user interface, wherein the information input by the user indicates at least the amount and/or type of advertisement content to be included in the product package. The system according to this aspect of the invention may further include a means for receiving the product package.

This invention also relates to another method for allowing a user to control the amount and/or type of advertising he or she receives with a product package. This method includes: (a) displaying an offer to sell a plurality of product packages to a user including at least a first product package and a second product package; (b) inputting a selection of one of the product packages; and (c) receiving a final product package based on the product package selected. The product packages contain the same (or substantially the same) product content, but different advertisement content (optionally, one product package may contain no advertisement content). In this example of the invention, the product packages are priced at different amounts, depending on the amount and/or type of advertisement content included with the product package. The product packages may differ slightly in product content, for example, if the advertisement content includes “product placement” type ads as described in more detail below.

Another aspect of this invention relates to a system for carrying out the method described immediately above. This system includes means for displaying the user interface information to the user, wherein the user interface information presents a plurality of product package offers to the user; and means for inputting the user's selection of one of the product packages. Systems according to this example of the invention also may include means for receiving a final product package based on the user's selection.

B. Flexible and Dynamic Advertisements

This invention also relates to methods and systems for making the advertisement content in a product more flexible and dynamic. One example of a method according to this aspect of the invention includes: (a) offering a product for sale, wherein the product includes a product content and at least one advertisement slot defined therein for potential insertion of advertisement content; (b) receiving a user's selection of a type or an amount of advertisement content desired along with the product; and (c) delivering a final product as directed by the user, wherein the final product includes the product content and the type or amount of advertisement content selected by the user, and wherein a final price of the final product depends, at least in part, on the type or amount of advertisement content selected by the user.

In this example, the advertisement slot(s) may be offered for sale to a plurality of potential advertisers. After the advertisement slot(s) are offered, the system manager or aggregator may receive at least one bid from the potential advertisers, wherein the bid indicates an amount that the potential advertiser will pay to place an advertisement in the advertisement slot in the final product. Then, the advertisement slot(s) will be awarded, optimally to the potential advertiser(s) making the highest bid(s). One or more ads from the selected potential advertiser(s) will then be included in the final product.

In order to make the ads more flexible and dynamic, the final product may include a “link” to an advertisement from the selected advertiser(s) to which an advertisement slot was awarded (e.g., a link to an internet or URL address including the advertisement), wherein the advertisement is displayed or downloaded as the final product is being used by or delivered as directed by the user. The advertisement may be displayed at any suitable time, for example, simultaneous with display of at least a portion of the product content, or while the final product is being downloaded or used. This “link” may allow advertisers to change or update ads after the initial download has occurred (the ad content provider may indicate how often to check to determine whether updated ads are needed). As used in this application, the term “link,” unless otherwise specified, simply refers to any suitable manner of storing ads externally from the product content, such as a file, a URL address, etc.

In certain examples of this aspect of the invention, the advertising party(ies) may change the advertisement content at any time at least until the final product is delivered as directed by the user. If the final product is used in an “on-line” environment, it may be possible for the advertiser to change the advertisement content at any time before the content is consumed. In this dynamic environment, if desired, the advertiser also may change the advertisement content after each time it is consumed by a user. Also, if desired, the advertisement content of the advertising party may be used to modify the actual product content of the final product (e.g., product placement in the text of an e-book or e-magazine).

The invention also relates to systems for performing the features of the invention as described immediately above. Such a system may include: (a) means for offering a product for sale, wherein the product includes product content and at least one advertisement slot defined therein for potential insertion of advertisement content; (b) means for receiving a user's selection of a type or an amount of advertisement content desired along with the product; and (c) means for delivering a final product as directed by the user, wherein the final product includes the product content and the type or amount of advertisement content selected by the user, and wherein a final price of the final product depends, at least in part, on the type or amount of advertisement content selected by the user. The system also may include one or more of the following: means for offering the advertisement slot(s) to potential advertisers, means for receiving bids from the potential advertisers for the advertisement slot(s), and means for inserting an advertisement in the final product from advertiser(s) to which the advertisement slot(s) was (were) awarded. The system according to this aspect of the invention also may include means for displaying the advertisement at an appropriate time.

Another example of a method according to the invention for making advertisements more flexible and dynamic includes: (a) offering a product for sale, wherein the product includes product content and at least one advertisement slot defined therein for potential insertion of advertisement content; (b) receiving an order from a user for a final product; (c) determining a number of available advertisement slots in the final product ordered by the user; (d) offering the available advertisement slots in the final product to a plurality of potential advertisers; (e) receiving bids from at least one of the potential advertisers for the available advertisement slots; (f) selecting one or more actual advertiser for the final product based at least in part on the bids received from the potential advertisers; and (g) delivering the final product as directed by the user, wherein the final product includes the product content and advertisement content from the actual advertisers. In this example, the specific product ordered by the user may dictate the number of available advertisement slots in the final product. If desired, the offer of advertisement slots may include information about the party ordering the product, so that the advertiser(s) may better determine whether they wish to advertise and/or which advertisement they may place in the final product. Optionally, the advertiser may supply the advertisement content to the system delivering the final product immediately before the product is delivered. The advertisement content also may include a link (e.g., an internet or URL address), as described above, so that the advertiser may freely change the advertisement at any time before it is downloaded, consumed, or reconsumed by the user.

The invention also relates to systems for performing the method described above. Such a system may include: means for offering a product for sale; means for receiving an order from a user for a final product; means for determining a number of available advertisement slots in the final product ordered by the user; means for offering the available advertisement slots to a plurality of potential advertisers; means for receiving bids from the potential advertisers for the available advertisement slots; means for selecting one or more actual advertiser for the final product based at least in part on the bids received from the potential advertisers; and means for delivering the final product as directed by the user, wherein the final product includes the product content and advertisement content from the one or more actual advertisers. The system further may include means for obtaining the advertisement content from at least one of the actual advertisers before delivering the final product as directed by the user, and/or means for inserting a link in the final product to a linked advertisement from at least one of the actual advertisers.

Another example of a dynamic and flexible advertising method according to the invention includes: (a) offering a product for sale, wherein the product includes product content and at least one advertisement slot defined therein for potential insertion of advertisement content; (b) offering potentially available advertisement slots to a plurality of potential advertisers; (c) receiving bids from the potential advertisers for the potentially available advertisement slots; (d) receiving an order from a user for a final product, wherein the final product ordered dictates a number of advertisement slots to be included in the final product; (e) selecting one or more actual advertiser for the final product based at least in part on the bids received from the potential advertisers; and (f) delivering the final product as directed by the user, wherein the final product includes the product content and advertisement content from the one or more actual advertisers.

Systems for performing the above method, which constitute additional examples of the present invention, may include: means for offering a product for sale, wherein the product includes product content and at least one advertisement slot defined therein for potential insertion of advertisement content; means for offering potentially available advertisement slots to a plurality of potential advertisers; means for receiving bids from the potential advertisers for the potentially available advertisement slots; means for receiving an order from a user for a final product, wherein the final product ordered dictates a number of advertisement slots to be included in the final product; means for selecting one or more actual advertiser for the final product based at least in part on the bids received from the potential advertisers; and means for delivering the final product as directed by the user, wherein the final product includes the product content and advertisement content from the selected advertisers.

Detailed Description of the FIGS.

The invention will be better understood in light of the following detailed description of the content of various FIGS.

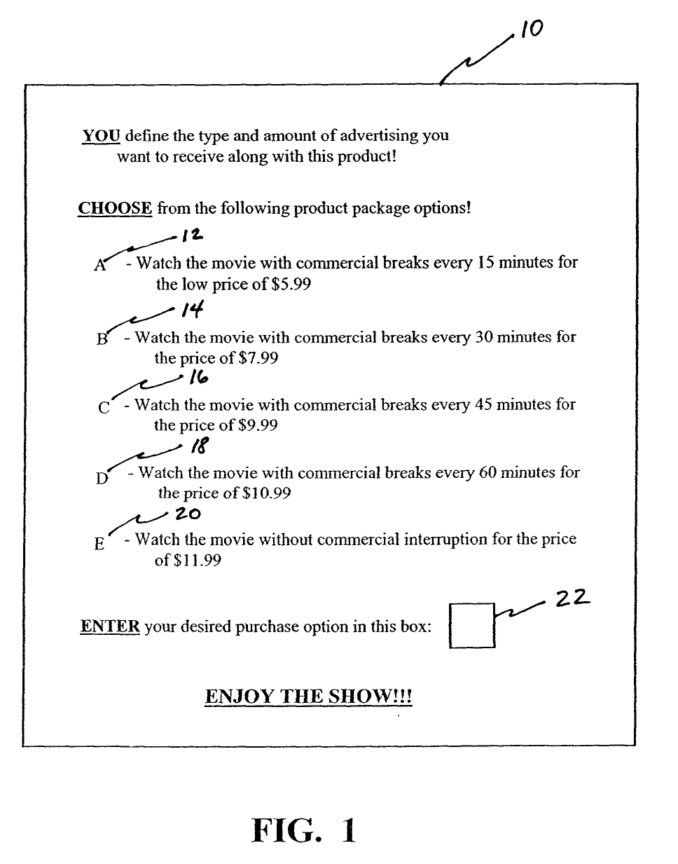

FIG. 1 illustrates an example of an information display 10 displayed to a user in one example of the invention wherein the user or purchaser is allowed to control, to some degree, the advertisement content in the product package. In this example, the user is exposed to a user interface in the form of displayed information 10 that defines several different product packages. While the illustrated example of the displayed information 10 defines five different, preselected product packages 12, 14, 16, 18, and 20, any number may be offered for sale without departing from the invention, so long as at least two different product packages are available. Notably, the prices of the product packages increase from Package A to Package E ($5.99 to $11.99), while the volume of advertisement content decreases from Package A to Package E (from commercials every 15 minutes to no commercials). In each of these product packages, the product content (e.g., the actual movie in the illustrated example) remains identical or substantially identical, but the overall advertisement content differs for each product package until product package E, which contains no advertisement content. Minor differences in the product content may exist, for example, to facilitate commercial insert.

The displayed information 10 may be generated in any suitable manner or appear on any suitable device, such as by using the systems illustrated in FIGS. 8 and 9. As additional examples, the displayed information 10 may be generated on a television screen, a computer or laptop screen, wherein the data is supplied via a set-top box, antenna, cable, modem, satellite, etc., in a conventional manner. As another exemplary alternative, the displayed information 10 may be generated on a personal digital assistant (PDA). The user interface information can be provided to the user display device in any suitable manner, such as over a computer network (e.g., the internet).

The displayed information 10 in the example of FIG. 1 includes an area 22 that will allow the user to input the selection of the desired product package. Any appropriate device or method for inputting information may be used without departing from the invention. For example, the information may be input using a keyboard, remote control, stylus, etc. Additionally, rather than using the entry box area 22, the selection information may be input in any other appropriate manner, for example, via a mouse click on the desired product package, through a pull-down menu, a “radio button,” etc. This selected information may be delivered to the product package supplier or others in any suitable manner, such as over a computer network, such as the internet.

Once the user's selection of a product package is received by the product package supplier (e.g., over a computer network such as the internet), the product package may be delivered to the user (or to someone else, if so directed) in any suitable manner. For example, the product package may be delivered on-line via email, modem, cable, satellite, etc.; off-line via disk, cassette, etc.; sent via mail or other courier; or directly picked up by the user or other person (e.g., at a store or warehouse). The user interface may include additional information displays, for example, displays that prompt the user or purchaser for credit card information, instructions regarding product package delivery, questions regarding demographic information, and the like.

In the example illustrated in FIG. 1, the product package offered is a movie (or another video product) with commercial breaks defined at various time periods throughout the show. This is just exemplary. As examples of other ways of making the advertising flexible, the user interface display may prompt the user to select the number of commercials to be viewed during each commercial break or the length of each commercial break. Other products also may be offered using this type of interface without departing from the invention. For example, the product content may be music or another audio product (e.g., an audio book, talk shows, etc.), wherein a user determines how many songs he will hear between commercial breaks, or how long he will listen between commercial breaks, or how long each commercial break will last, etc. As another example, the product also may be a software product, wherein advertisement breaks are included before, during, and/or after the product is downloaded or in a sidebar every time the program is run.

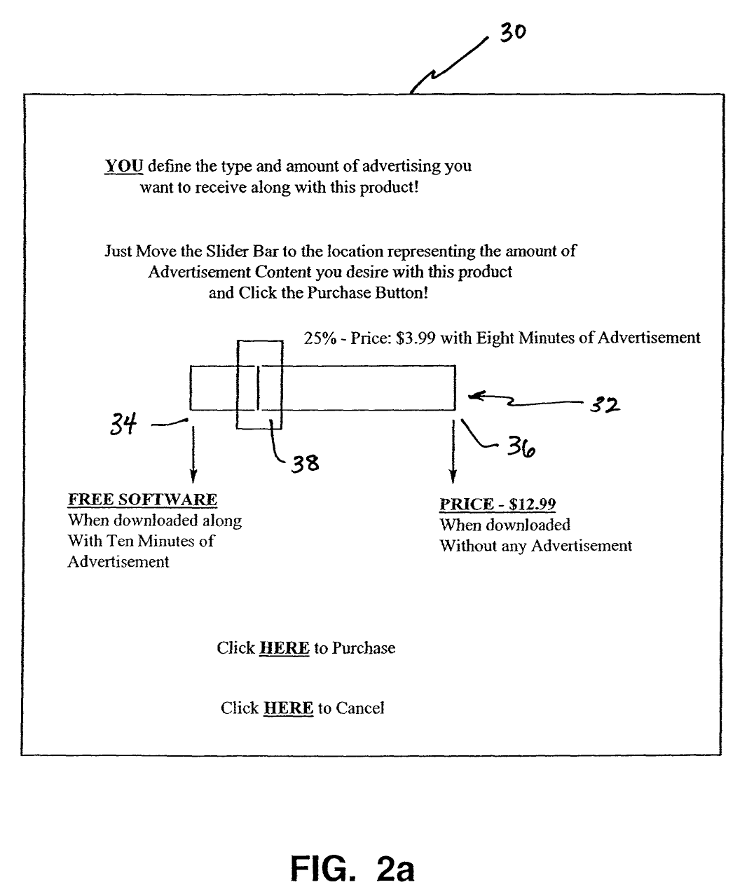

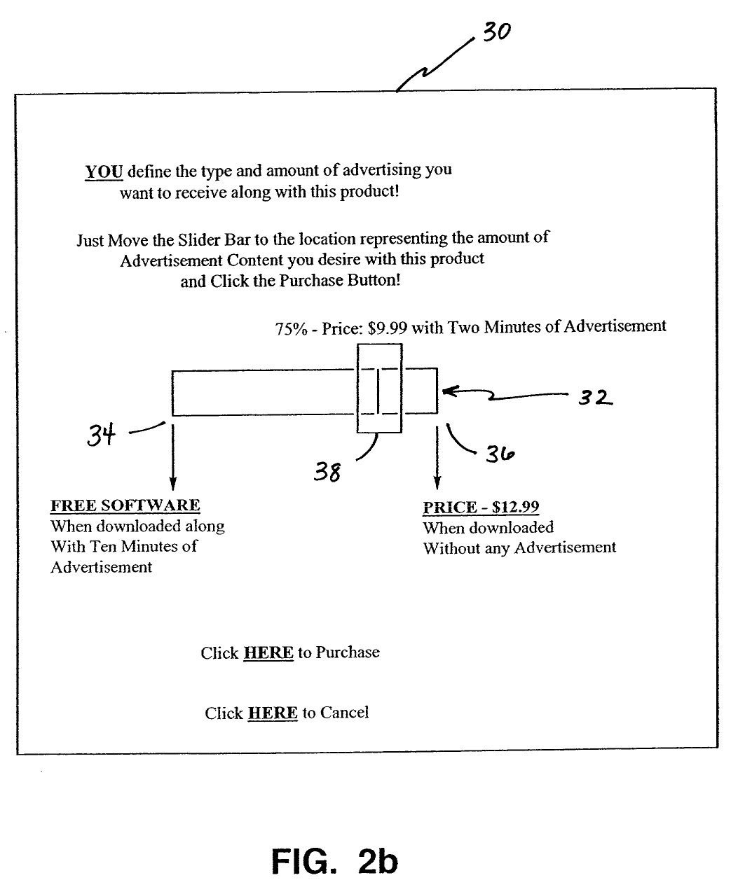

FIGS. 2a and 2b illustrate another example of a user interface display that may be used according to various aspects of the invention. Again, this user interface includes an information display 30, but in this instance the interface offers software product packages to the user. In this example, all available product packages are not clearly spelled out in a listing like that shown in FIG. 1. Rather, the product packages are offered as part of a continuum 32, wherein a relatively inexpensive product package 34 with a certain amount of advertisement content is located at one end of the continuum (in this example, the product is free with ten minutes of advertisement time) and a “premium” version of the product package 36 is located at the opposite end of the continuum (in this example, the product costs $12.99, but contains no advertisements).

A comparison of FIGS. 2a and 2b illustrates the manner in which different product packages are offered to the user in this example. By moving the slider bar 38 along the continuum 32 (e.g., using a mouse, stylus, finger, or remote control), the interface user is able to change the advertisement content in the product package (and thereby define different product packages). As examples, in FIG. 2a, the software package highlighted by the slider bar 38 costs $3.99 and contains eight minutes of advertisement content. In FIG. 2b, however, the slider bar 38 has moved to the right, and the software package highlighted by the slider bar 38 costs $9.99, but it contains only two minutes of advertisement content. The user also may be able to directly select the product packages at the ends of the continuum (in a conventional manner) without moving the slider bar 38. As described above with respect to FIG. 1, additional information displays in the user interface may be included to enable the user to input credit card information, delivery instructions, or other information. Also, products other than software and other advertisement and timing options may be offered using this type of continuum system without departing from the invention.

Rather than having predefined product packages from which the user selects a desired option, the user interface may prompt the user to directly define or select her own product package, e.g., by selecting a desired price (“I want to pay $5.00”) or a desired volume of advertisement content (“I want X minutes of ads”). Given the user's input, the system may then determine the appropriate volume of advertisement content or price (depending on which parameter was selected by the user), and create an appropriate product package. This product may then be delivered to the user by any conventional means (like those described above), and the user would be charged an appropriate price for the product package. Of course, the user could be allowed to change the parameters (e.g., to specify different ad content or price) before committing to the sale.

Various different ways of presenting the advertisement content to the user also may be used in methods and systems according to this invention. While the following briefly describes some examples, it is not an exhaustive listing of the possibilities.

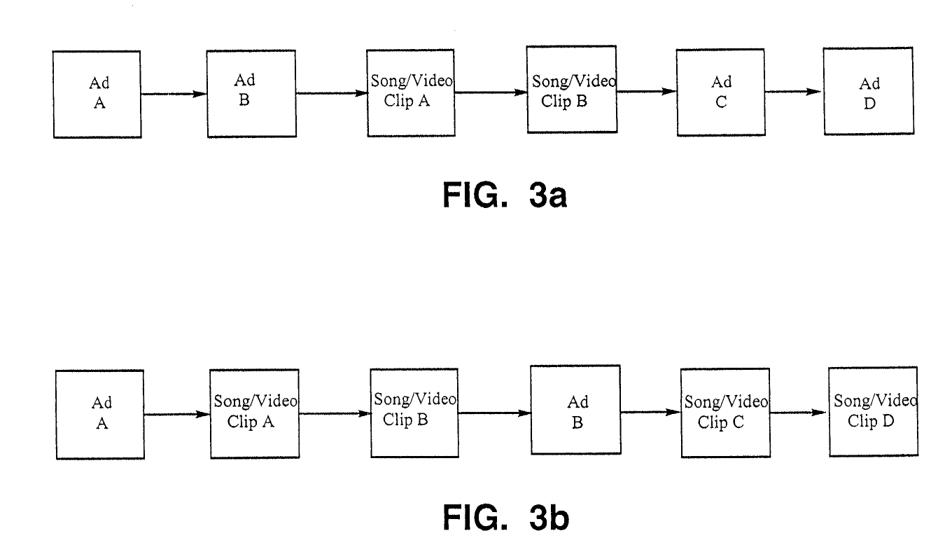

As one example, the advertisements may be “in stream,” i.e., the ads exist in the same stream as the product content, but the advertisement content and the product content generally do not overlap or mix together during their presentation. An example of this type of advertisement is illustrated in FIGS. 3a and 3b. FIG. 3a shows a first product package (e.g., a music or video product) wherein the user views two advertisements, then two songs or video clips (or a certain length of a movie or show), and then two more advertisements. This type of advertisement presentation may continue until the product content is fully consumed or the user chooses to stop. FIG. 3b illustrates a higher priced or “premium” version of the product package where less advertisement content is present (only one advertisement for the same number of songs or video clips). In the systems illustrated in FIGS. 3a and 3b, like conventional commercial television or radio programs, the information being presented to the user at any given time typically is either product content or advertisement content, but generally not both simultaneously (although it is possible for both to exist simultaneously). These systems work well, for example, for advertisement content and product content delivered via broadcast media, via cassette or disk, and/or via a binary stream of data (e.g., on-line, over the internet, on disk, etc.).

In order to make systems like those illustrated in FIGS. 3a and 3b more flexible or dynamic, the user may be able to control or dictate the amount of advertisement content. For example, the user may control the length of product content between advertisement breaks and/or the length of the advertisement content (e.g., minutes of advertisement time, number of advertisements, etc.). The price charged for the product is governed, at least in part, based on the overall amount of advertisement content selected by the user to be delivered with the product content.

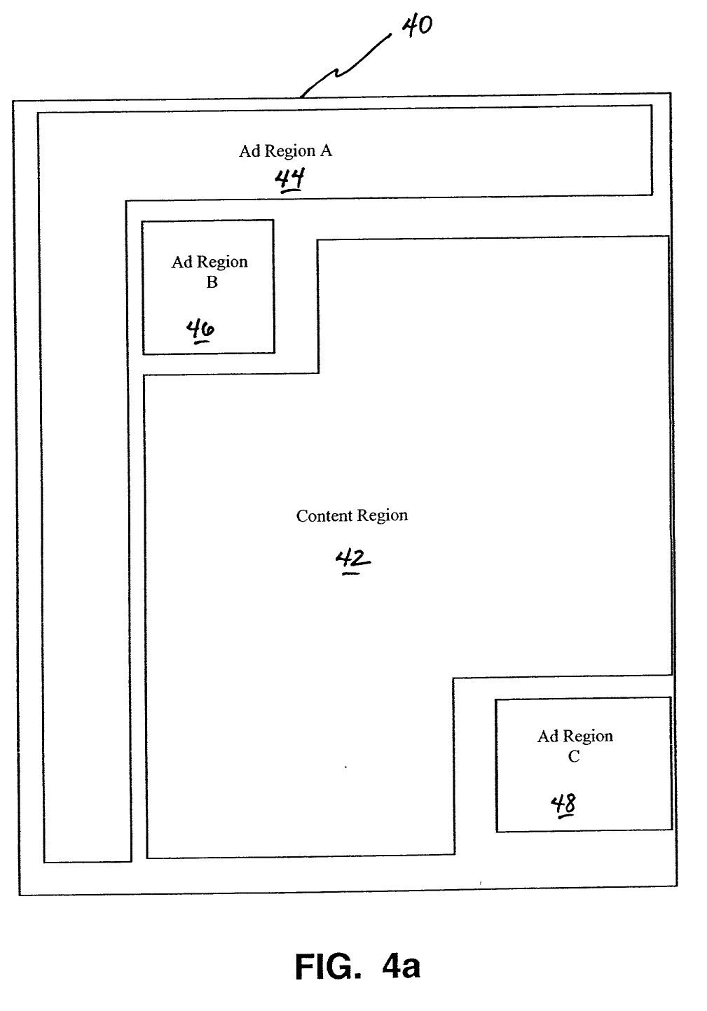

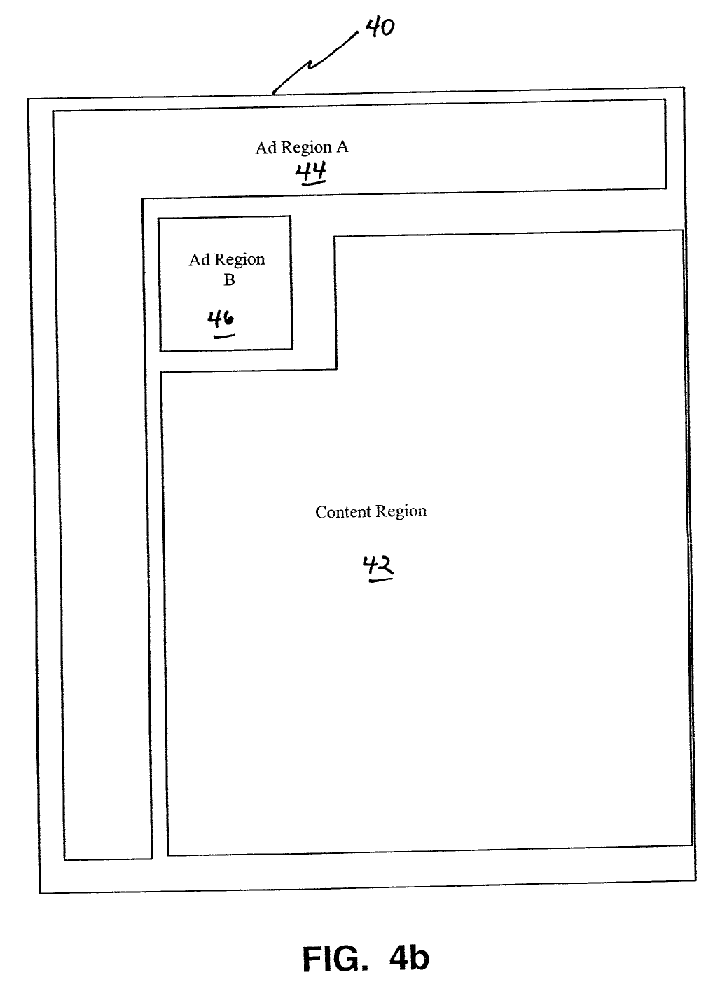

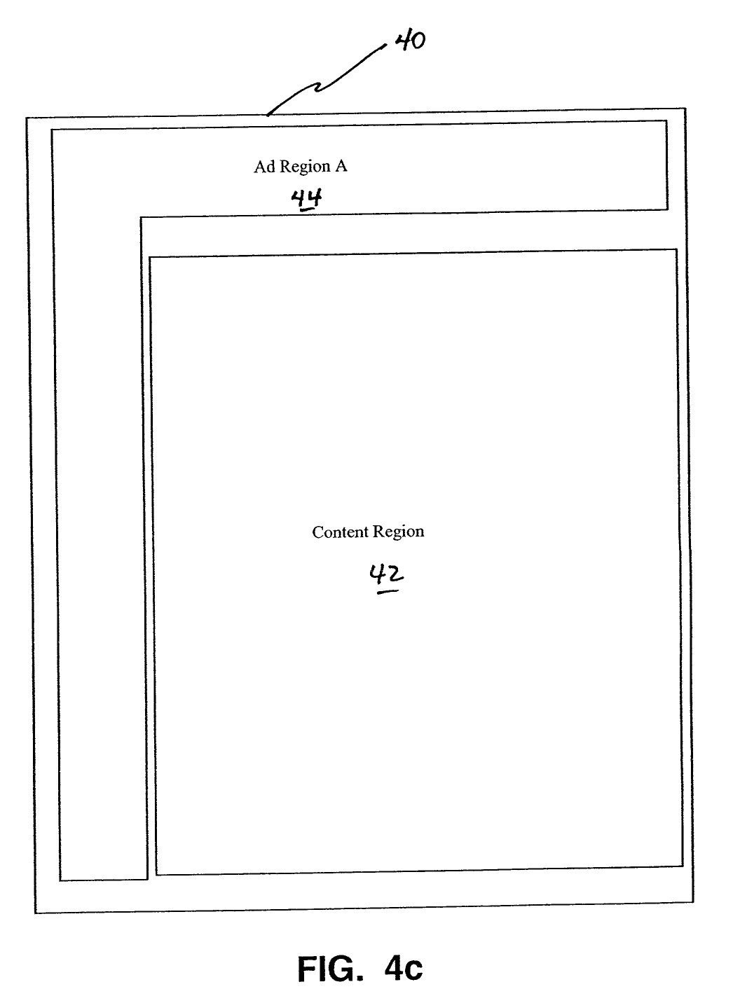

FIGS. 4a through 4c illustrate another example of advertisement content delivery useful in accordance with the invention. In these examples, the advertisement content is presented to the user simultaneously with and adjacent the product content. In this type of advertising, modifying the overall advertisement content does not change the product content, but it may change the manner in which the product content is laid out. This type of advertisement layout is similar to that presently used in conventional newspapers and periodicals. While methods and systems according to the present invention also may be used with conventional “hard” copy systems (such as paper periodicals and newspapers), this aspect of the invention works particularly well with electronic products, such as, e-books, e-magazines, videos, on-line magazines and newspapers, etc. As examples, the ads may scroll up and down with the product content, the ads may remain in the same location during scrolling and/or page turning, and/or new ads may appear on every page of the product content.

FIGS. 4a through 4c illustrate examples of one page of three different product packages that might be put together in a method and system according to this aspect of the invention. The overall page 40 of the product package illustrated in FIG. 4a includes a product content region 42 and three advertisement regions 44, 46, and 48. For a higher product package price, the purchaser may obtain the product package illustrated in FIG. 4b, in which the overall page 40 includes a larger content region 42 and two advertisement regions 44 and 46. For a still higher price, the product package may look like that illustrate in FIG. 4c, in which the page 40 contains only one advertisement region 44. As will be apparent to those skilled in the art, the advertisement and product content layouts may be adjusted in many different ways, without departing from the invention. For example, one advertisement may be a banner type advertisement like those commonly used on line in the internet environment.

In this exemplary system, the overall product content may remain the same (or substantially the same) over the packages illustrated in FIGS. 4a through 4c, but its position, size, or overall layout may change, depending on the selected product package. For example, the overall product package of FIG. 4a may contain more total pages than the pages in the product packages of FIGS. 4b and 4c in order to accommodate the increased number of advertisements in the package (i.e., because each page of the package contains more advertisement space, the package contains more pages to provide the same product content). Also, each individual page of the overall product package need not include the same advertisement content, number of advertisements, or layout of advertisements as the other pages.

As generally described above, many flexible advertising methods and systems according to the invention are well suited for the electronic environment, where the product content and advertisement content are delivered electronically (e.g., over a computer network such as the internet) and communications between the product provider and the user are conducted electronically (over a computer network, such as the internet).

In accordance with another electronically based example of the invention, the user may make his or her product package selection, and then the system may download that particular product package. Alternatively, as another example, the user may order the product content, which may be downloaded with multiple advertisement options. Then, when the user proceeds to consume the product content (optionally in an off-line environment), he or she may decide at that time the amount of advertisement content desired. By downloading multiple advertisement options along with the product content, this would enable the user to “upgrade” to a more premium product package, or “downgrade” to a more heavily advertisement content product package. The system could then apply additional charges or credits to the user's account, as necessary, to account for any upgrades or downgrades, either as the upgrade or downgrade is occurring or the next time the user goes on-line with the device.

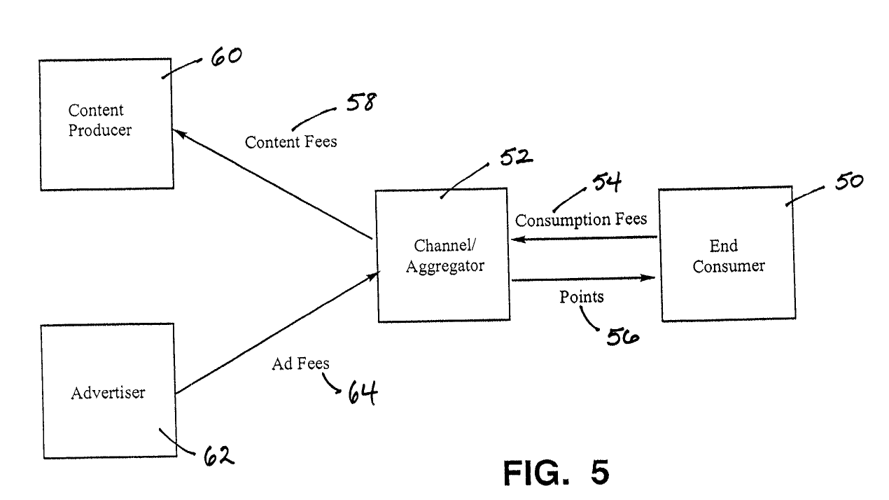

Another aspect of this invention relates to a dynamic marketplace for matching advertisers, content providers, and end users. FIG. 5 illustrates a simple example of parties that may be involved in providing and using typical product packages and the manner in which the money flows in this exemplary arrangement. As illustrated, an end consumer or purchaser 50 obtains the overall product packages from an aggregator 52, and the purchaser 50 may pay consumption fees 54 to the aggregator 52 (unless the product package is free). As incentives to the consumer 50, the aggregator 52 may “pay” the consumer 50 some type of bonus points 56, through which the consumer 50 may obtain free or discounted products or services (akin to “frequent flier miles” or other common incentive programs). Also, if the consumer 50 selects product packages having advertisement content, he or she could accrue bonus points 56, as an inducement to consume ads (like being “paid” to view advertisement content).

The aggregator 52 is responsible for compiling the product content and advertisement content (if any) and making this compiled product package available to the user. To do so, the aggregator 52 pays content fees 58 to one or more content producers 60. In order to reduce the cost of the product content, the aggregator may seek advertisers 62, who will pay advertising fees 64 to the aggregator 52 in order to transmit their advertisement content to the end consumer 50 along with the product content.

Of course, FIG. 5 merely illustrates an example of parties that may be involved. A single entity may play more than one role in FIG. 5 without departing from the invention. For example, the aggregator could be the same entity as the content producer and/or as one of the advertisers without departing from the invention. Additionally, any given product may include content from several different content providers and advertisers, as well as several different customers purchasing the product.

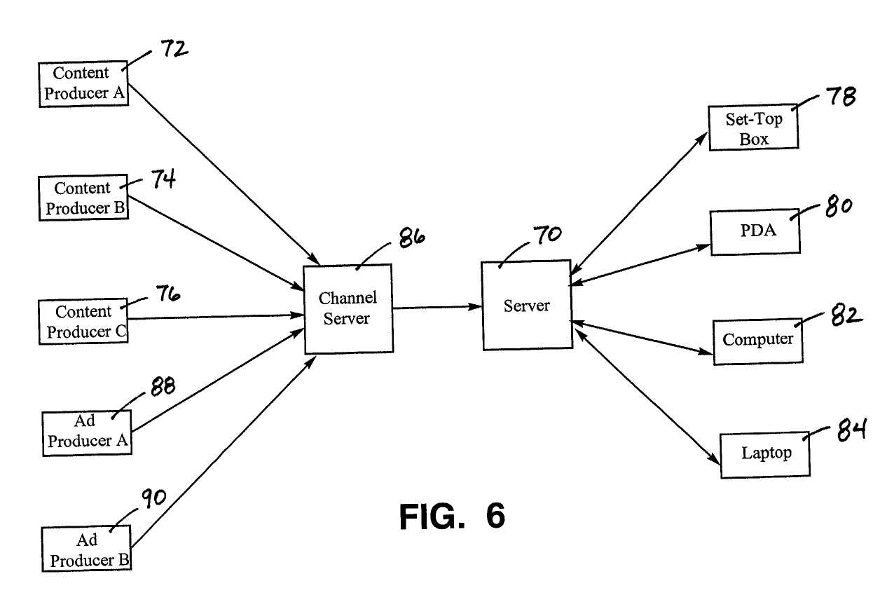

FIG. 6 illustrates an example of a network that may be involved in providing product packages to an end user according to this invention. In this network, a trusted content server 70 sits between multiple content producers 72, 74, and 76 and one or more devices of the end user (e.g., a set-top box 78, a personal digital assistant (“PDA”) 80, a computer 82, or a laptop 84). A channel server 86 collects information from the users, content producers 72, 74, and 76, and potential advertisers 88 and 90. Once the appropriate product package is compiled, the final product package may be delivered to the appropriate end user device. Notably, a single machine may theoretically conduct the functions of the channel server 86 and the trusted content server 70, although their roles are conceptually distinct.

The channel server 86 or another suitably situated computer may perform many functions in accordance with various examples of this invention. For example, the channel server 86 (or another computer) may function as a “means for providing the user interface” by furnishing electronic signals (directly or indirectly) that enable creation and/or display of a user interface. In this same way, the channel server 86 (or another computer) may function as the “means for offering product packages” to the user, because the product packages may be described and offered for sale via the user interface. Also, the channel server 86 (or another computer) may function to receive information input by the user through the user interface (and thus serve as a “means for receiving information input by a user” or “means for receiving a selection from the user”). Once the product order is received, the channel server 86 (or another computer) may function as the “means for charging” or “means for billing” the purchaser by directly or indirectly initiating the charging or billing process (e.g., by sending signals needed to obtain credit card information, by sending signals to initiate generation and sending of a bill, etc.). The channel server 86 (or another suitable computer) also may directly or indirectly deliver the product package as directed by the user (e.g., on line, over a network, etc.) or initiate the steps necessary to assure that the product package is so delivered (e.g., by sending signals needed to assure mailing of the product package, obtaining the product package from inventory, etc.). Thus, in this manner, the channel server 86 or other suitable computer may serve as a means for delivering the product package. In any given system, one or more computers may be used to perform the desired functions, and these computers may be suitable located anywhere, e.g., at the same location as the user or at another location.

Systems according to the invention also may include “means for displaying a user interface” to a user. This may include, for example, a set top box, a television set, a PDA screen, a computer screen, a laptop screen, a tablet PC screen, a monitor, etc., like those described in conjunction with FIGS. 6, 8, and 9. Optionally, these same devices may be used for displaying the advertisement content and product content once the product is delivered. “Means for inputting information” include, for example, any suitable user input devices like those described above in conjunction with FIGS. 8 and 9. The “means for receiving” the product package may include, for example, systems for receiving and/or downloading information like those described above in conjunction with FIGS. 8 and 9 (e.g., computer memory, disks, etc.).

A computer system, such as channel server 86, also can function to communicate with potential advertisers, offer available advertisement slots for sale to the potential advertisers, determine the number of available slots and receive bids for advertisement slots. Computer systems, like those described above, also can be used to determine which bids to accept (i.e., selecting the advertisers to which slots will be awarded) and to obtain the advertisement content from an advertiser. If desired, a computer system can be used to link to the advertisement of the advertiser when the product content is being downloaded, delivered, and/or consumed.

In practicing aspects of the invention that involve user control of the amount of advertisement content, the content providers need not deliver multiple product formats, i.e., —one for each different product package or advertisement content level (although that is one possible way of practicing the invention). Rather, the content provider may merely structure their content with slots in which advertisements potentially may be filled. Then, when the user selects a product package (and thereby dictates the amount of advertisement content to be included with it), the appropriate number of advertisement slots may be filled in the product content. As one example, XAML (transaction authority markup language) may be used to designate or express where advertisement can be placed relative to product content.

The invention also relates to systems and methods for “auctioning” advertising slots to potential advertisement providers. In one example of this aspect of the invention, the advertisement slot(s) in the product package selected by the user may be offered to a plurality of potential advertisers. The potential advertisers may then bid on any number of the advertisement slots (e.g., advise the aggregator how much they would be willing to pay to place their ad in an advertisement slot). The aggregator or other party supplying the product package to the user or purchaser may then determine which bid(s) to accept (e.g., the highest bidder), and award the advertisement slot(s) to the selected advertiser(s). At the appropriate time, the advertisement(s) of the selected advertiser(s) may be included in the product package that is delivered to the user or purchaser.

The advertisement content may be placed within the product content in any suitable manner without departing from the invention. For example, if desired, the advertiser may supply the specific advertisements directly to the aggregator, who may then place them in the product content. However, in order to make the advertisements more flexible and dynamic, the advertisement slot(s) in the final product may be structured to link to an advertisement maintained by the selected advertiser for the slot(s) (e.g., via a computer network, such as over the internet), such that the advertisement will be displayed as the final product is being delivered to or used by the eventual user. In this manner, if desired, the advertiser may freely change the advertisement content at any time, at least until the final product is downloaded by or delivered to the user. Additionally, in this example of the invention, if desired, the advertisement content may be changed such that a second use of the final product may result in the display of different advertisement content than that displayed during the first use (e.g., the advertiser could change the maintained advertisement between the first and second use of the product or the advertiser could change ads based on the user's behavior while consuming the product content).

This advertisement auctioning aspect of the present invention may be used in conjunction with any of the various advertisement types discussed above. For example, the auction may be used for advertisements displayed simultaneously with at least a portion of the product content (e.g., like those shown in FIGS. 4a through 4c). As additional examples, the advertisements also may be displayed as the final product is being downloaded by the user, or sequentially as the product content is being delivered (e.g., as shown in FIGS. 3a and 3b). Additionally, in the advertisement auctioning aspect of the invention, the advertisement slots need not all be awarded to a single advertiser, nor do the advertisement slots in subsequent product packages need to be awarded to the same advertisers as those awarded advertisements in the first product package. Rather, each product package may include advertisements from several different advertisers, assuming that the selected product package includes a plurality of advertisement slots, and each individual product package may include a different set of advertisers and/or advertisements.

Another aspect of this invention relates to the ability to modify the actual product content to include an advertisement from an advertiser, e.g., “product placement” in the content. As an example, assume the product content is a spy novel in the form of an e-book. The text of the book may include a high speed chase scene wherein the hero outruns the enemy and narrowly escapes death. While a generic version of the text may simply refer to the hero's automobile as a “sports car,” the product text may be structured as an advertisement slot, and this slot may be sold to an automobile manufacturer, such as BMW or Porsche. Then, the advertisement containing versions of the e-book might describe the chase scene wherein the hero outruns the enemy is his or her BMW or Porsche automobile. A second sold version of the product package may include a different product placement advertisement than the first such that one user's version of the e-book may refer to a Porsche automobile and a second user's version might refer to a BMW automobile. In this manner, the product content may differ somewhat from package to package, but the overall product content is “substantially” the same. Minor differences in product content from product to product also may occur in order that the advertisement content fits in smoothly with the product content.

The auction of the advertisement slots may work in a variety of different ways. For example, an auction may take place each time a product package is ordered by a user and the number of available advertisement slot(s) is determined. As another alternative, the aggregator or supplier of the final product package may hold an auction for advertisement slots before the product packages are sold. Advertisers could bid on potentially available advertisement slots, and the aggregator could fills the slots as the product package orders come in. For example, one advertiser could offer to purchase 1000 slots at 8¢ each, a second advertiser could offer to purchase 750 slots at 7¢ each, and a third advertiser could offer to purchase 500 slots at 5¢ each. As the product package orders come in, the aggregator could fill them with an ad from the highest available bidder or in any other desired manner. As another example, advertisements from certain advertisers may be designated as “must” or “use first” ads, if the advertiser is willing to pay an upfront, non-refundable “slotting fee” (e.g., 1¢ per ad) to guarantee that the aggregator will first select his advertisements and then another “display fee” or “fulfillment fee” (e.g., 6¢ per ad) when the advertisement is actually placed in product content. Other advertisements may be designated as “dynamic” or “optional” wherein the aggregator will use this advertisement unless another advertiser makes a higher bid. Any possible bid structures may be used without departing from the invention.

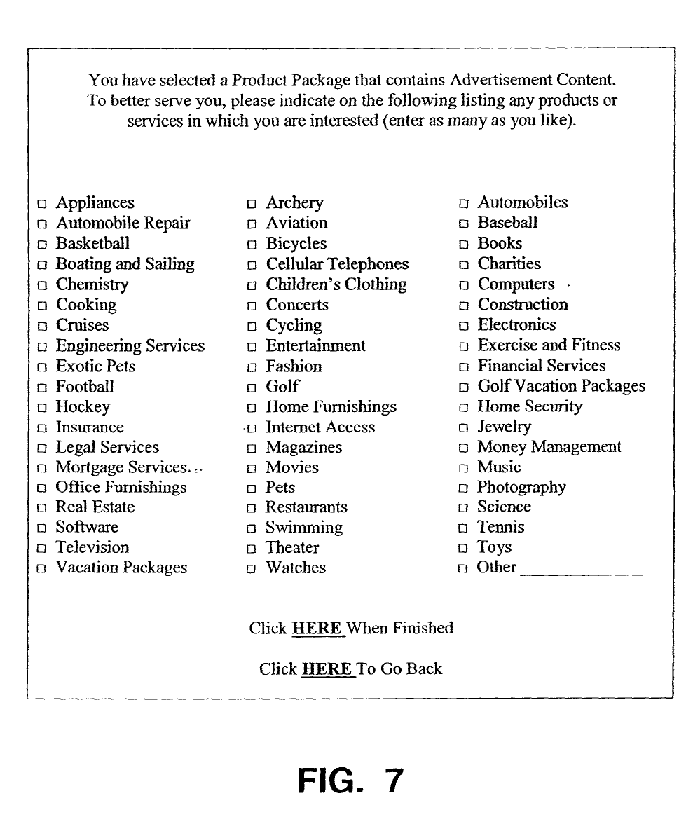

Another aspect of this invention relates to the ability for advertisers to tailor their advertisement content to the specific user or purchaser of the product package. As an order for a product package is input or accepted, the user may be prompted to input personal or demographic information (e.g., address, age, sex, number of children, occupation, etc.), or the user may be asked if he or she has an interest in seeing advertisement content relating to any specific products or services (see, for example, FIG. 7). This type of information may be passed on to the potential advertisers, who may then use it in crafting their bid, if they wish, to increase their chances of presenting a successful bid. As another example, the aggregator may use this information to target potential advertisers and/or to select ads for the final product package from a volume of ads available from the potential advertisers. The consumer could be offered a better deal if they take the time to fill out the requested information.

Users also could be prompted to select the actual type of advertisements received. For example, if the user dislikes commercial interruption but does not mind receiving “flyer” type ads, they may select a suitably designed product package option. Of course, the prices for the product packages and the advertisements may vary, depending on the type of ads.

Systems and methods of this invention also may include ways to assure that consumers who purchase product packages with advertisement content actually view (or at least display) the ads they receive. In other words, the purchaser should not be able to tamper with the product package to remove ads or have software that blocks the ads. As an example of one way to accomplish this, the software that allows the user to obtain or “consume” the product content may be a trusted application that can make sure that access to the product content is allowed only when things are “all clear,” e.g., no malicious applications are running that would destroy or block the advertisement content. This is a form of digital rights management (“DRM”).

Some systems and methods according to the invention also may lend themselves to other forms of digital rights management, if desired, for example, using extensible rights markup language (“XrML”). As one non-limiting example, after purchasing a product containing a specific amount of advertisement content, the systems and methods according to the invention could evaluate the purchaser's use of the product. For example, a data structure could be created in which information is stored indicating the amount of time the advertisement content spends on the user's screen or indicating whether the user made efforts to delete, deactivate, or otherwise tamper with the advertisement content. When the user is “on line,” information from this data structure may be accessed by the aggregator, who can then confirm whether the advertisement content was sufficiently displayed (e.g., the ad content spent sufficient time on the user's screen) and/or whether the product package files were tampered with to remove, deactivate, or otherwise tamper with the advertisement content. If the system determines that the advertisement content was not reviewed or was removed or disabled, additional charges may be levied (corresponding to the premium product package) or other appropriate action may be taken.

Another exemplary way of helping to assure that advertisement content is actually reviewed by the purchaser, at least to some degree, is to structure the ads so that the user must interact with the system in some way before the product content proceeds. For example, after an advertisement is displayed, the user may be required to click on a button in order to proceed with the product content (e.g., an “OK” or “CONTINUE” type button).

As mentioned above, some systems and methods according to this invention may use extensible markup language (“XML”), such as transaction authority markup language (“XAML”) to designate ad placement. As an example, in using such systems and methods, the user may be presented with an “offer list,” i.e., a set of offers corresponding to various available product packages. Each offer may map to a corresponding “topology,” which fixes how or when the ads are displayed and/or arranged with respect to the product content (e.g., like the various topologies shown in FIGS. 3a-3b (in stream ads) and 4a-4c (in line ads)). When interacting with such systems or using such methods, the user may enter information indicating one or more of various parameters (e.g., number of ads desired, price desired, number of songs between ads, number of minutes between ads, number of chapters between ads, etc.) corresponding to something in the “offer list,” and the information entered by the user dictates the topology of the product package.

As an example, assume the user selected a product package option wherein he will listen to two advertisements for every two songs played. The topology of this product package may look like that shown in FIG. 3a. The XML file for this in stream ad topology may look as follows:

<?xml>

<ad type=must src =ad1.mpeg/>

<ad type=optional src =ad2.mpeg/>

<content rid=1 src=a.mpeg/>

<content rid=2 src=b.mpeg/>

<ad type=must src=ad3.mpeg/>

<ad type=optional src=ad4.mpeg/>

<content rid=3 src=c.mpeg/>

<content rid=4 src=d.mpeg/>.

In this example, first mpeg files for two ads are presented, then mpeg files for two songs are presented (i.e., product content), and then another two ads, another two songs, etc. If desired, the ad types may be designated “must” and “optional,” as in this example, for the ad auction aspects of the invention discussed above (“must” ads receive highest priority because a “slotting fee” was paid, whereas “optional” ads may be superseded, if a better offer is received).

Likewise, various topologies for in line advertisements (like FIGS. 4a-4c) also can be developed corresponding to the product package selected. In this case, the advertisement location and content may be commingled in the code with the product content. As an example, the topology could correlate specific portions of the product content with corresponding advertisement content (e.g., when displaying chapter 12, also display advertisements A, B, and C at locations X, Y, and Z, respectively). As another example, the in line product content could be commingled with advertisements having various “priorities” or “flexibilities” (e.g., certain ads “must” stay in place, while other ads are “optional” and could be superceded (e.g., if a better offer is received from another advertiser) or deleted (e.g., if a premium product package is chosen)).

Of course, there are an infinite number of possible product packages and layouts containing different combinations and permutations of product content and advertisement content. Those of ordinary skill in the art can prepare code corresponding to the desired topology.

While the invention has been described in terms of various specific examples, these specific examples merely exemplify the invention and do not limit it. Those skilled in the art will appreciate that changes and modifications may be made to these examples without departing from the spirit and scope of the invention, as defined in the appended claims.

We claim:

1. A method, comprising:
providing a user interface that enables a user to define a product package, wherein the product package includes a product content and optionally an advertisement content, wherein the user interface allows the user to select an amount or type of advertisement content to be included in the product package;
receiving input information from the user indicative of the amount or type of advertisement content to be included in the product package; and
charging the user for the product package, wherein a final price of the product package is determined, at least in part, based on the amount or type of advertisement content selected by the user.

2. A method according to claim 1, further comprising: delivering the product package in a manner directed by the user, wherein the product package delivered includes the amount or type of advertisement content selected by the user.

3. A method according to claim 2, wherein the product package is delivered over a computer network system.

4. A method according to claim 1, wherein the user interface enables the user to define a product package between a minimum price and a maximum price, wherein the minimum price product package includes a maximum amount of advertisement content and the maximum price product package includes no advertisement content.

5. A method according to claim 1, wherein the user interface enables the user to define a product package between a minimum price and a maximum price, wherein the minimum price product package includes a maximum amount of advertisement content and the maximum price product package includes a minimum amount of advertisement content.

6. A method, comprising:
defining a plurality of product packages including at least a first product package and a second product package, wherein the first product package includes at least a first product content and a first advertisement content, and wherein the second product package includes at least the first product content;
offering to sell the plurality of product packages to a user, wherein the first product package is offered to the user at a first price and the second product package is offered to the user at a second price, wherein the first price is different from the second price;
receiving the user's selection of one of the plurality of product packages; and
delivering a final product package based on the user's selection.

7. A method according to claim 6, wherein the second product package includes a second advertisement content, wherein the second advertisement content is different from the first advertisement content.

8. A method according to claim 7, wherein the plurality of product packages further includes at least a third product package, wherein the third product package includes at least the first product content, and wherein the third product package is offered to the user at a third price, wherein the third price is different from the first price and the second price.

9. A method according to claim 8, wherein the third product package includes a third advertisement content, wherein the third advertisement content is different from the first advertisement content and the second advertisement content.

10. A method according to claim 6, wherein the plurality of product packages are offered to the user in a form such that the user selects a payment price, and the final product package contains an amount of advertisement content based on the payment price selected by the user.

11. A method according to claim 6, wherein the plurality of product packages are offered to the user in a form such that the user selects an amount of advertisement content desired with delivery of the final product package, and the final product package contains the amount of advertisement content selected by the user.

12. A method according to claim 6, wherein the plurality of product packages are offered to the user in the form of a continuum, wherein the first price and the first advertisement content are located at a first end of the continuum and the second price and no advertisement content are located at a second end of the continuum, wherein a price of the product package increases from the first end to the second end of the continuum and a volume of the advertisement content in the product package decreases from the first end to the second end of the continuum.

13. A method according to claim 6, wherein the plurality of product packages are offered to the user in the form of a continuum, wherein the first price and the first advertisement content are located at a first end of the continuum and the second price and a second advertisement content are located at a second end of the continuum, wherein a price of the product package increases from the first end to the second end of the continuum and a volume of the advertisement content in the product package decreases from the first end to the second end of the continuum.

14. A system, comprising:
means for providing a user interface to a user, wherein the user interface enables the user to define a product package including a product content and optionally an advertisement content, and wherein the user interface enables the user to select an amount or type of advertisement content to be included in the product package;
means for receiving information input by the user through the user interface, wherein the information input by the user indicates at least the amount or type of advertisement content to be included in the product package; and
means for charging the user for the product package, wherein a final price of the product package is determined, at least in part, based on the amount or type of advertisement content selected by the user.

15. A system according to claim 14, further comprising: means for delivering the product package in a manner directed by the user, wherein the product package delivered includes the amount or type of advertisement content selected by the user.

16. A system according to claim 15, wherein the means for delivering the product package delivers the product package over a computer network system.

17. A system, comprising:
means for offering a plurality of product packages for sale to a user, wherein the product packages include at least a first product package and a second product package, wherein the first product package includes at least a first product content and a first advertisement content, and wherein the second product package includes at least the first product content, and wherein the first product package is offered for sale to the user at a first price and the second product package is offered for sale to the user at a second price, wherein the first price is different from the second price;
means for receiving the user's selection of one of the plurality of product packages; and
means for delivering a final product package based on the user's selection.

18. A system according to claim 17, wherein the second product package includes a second advertisement content, wherein the second advertisement content is different from the first advertisement content.

19. A system according to claim 18, wherein the means for offering the plurality of product packages further offers at least a third product package to the user, wherein the third product package includes at least the first product content, and wherein the third product package is offered for sale to the user at a third price, wherein the third price is different from the first price and the second price.

20. A system according to claim 19, wherein the third product package includes a third advertisement content, wherein the third advertisement content is different from the first advertisement content and the second advertisement content.

21. A system according to claim 17, wherein the means for offering offers the plurality of product packages to the user in a form such that the user selects an amount of advertisement content desired with delivery of the final product package, and the means for delivering the final product package delivers the final product package corresponding to the amount of advertisement content selected by the user.

22. A system according to claim 17, wherein the means for offering offers the plurality of product packages to the user in the form of a continuum, wherein the first price and the first advertisement content are located at a first end of the continuum and the second price and no advertisement content are located at a second end of the continuum, wherein a price of the product package increases from the first end to the second end of the continuum and a volume of the advertisement content in the product package decreases from the first end to the second end of the continuum.

23. A system according to claim 17, wherein the means for offering offers the plurality of product packages to the user in the form of a continuum, wherein the first price and the first advertisement content are located at a first end of the continuum and the second price and a second advertisement content are located at a second end of the continuum, wherein a price of the product package increases from the first end to the second end of the continuum and a volume of the advertisement content in the product package decreases from the first end to the second end of the continuum.

24. A method, comprising:
displaying a user interface that enables a user to define a product package, wherein the product package includes a product content and optionally an advertisement content, wherein the user interface allows the user to select an amount or type of advertisement content to be included in the product package;
inputting information indicative of the amount or type of advertisement content to be included in the product package; and
receiving the product package, wherein a final price of the product package received is determined, at least in part, based on the amount or type of advertisement content selected by the user.

25. A method, comprising:
displaying an offer to sell a plurality of product packages to a user, wherein the plurality of product packages includes at least a first product package and a second product package, wherein the first product package includes at least a first product content and a first advertisement content, and wherein the second product package includes at least the first product content, wherein the first product package is offered to the user at a first price and the second product package is offered to the user at a second price, wherein the first price is different from the second price;
inputting a selection of one of the plurality of product packages; and
receiving a final product package based on the product package selected.

26. A method according to claim 25, wherein the second product package includes a second advertisement content, wherein the second advertisement content is different from the first advertisement content.

27. A method according to claim 26, wherein the plurality of product packages further includes at least a third product package, wherein the third product package includes at least the first product content, and wherein the third product package is offered to the user at a third price, wherein the third price is different from the first price and the second price.

28. A method according to claim 27, wherein the third product package includes a third advertisement content, wherein the third advertisement content is different from the first advertisement content and the second advertisement content.

29. A system, comprising:
means for displaying a user interface, wherein the user interface enables a user to define a product package including a product content and optionally an advertisement content, and wherein the user interface enables the user to select an amount or type of advertisement content to be included in the product package; and
means for inputting information through the user interface, wherein the information input by the user indicates at least the amount or type of advertisement content to be included in the product package.

30. A system according to claim 29, further comprising:
means for receiving the product package, wherein a final price of the product package is determined, at least in part, based on the amount or type of advertisement content selected by the user.

31. A system, comprising:
means for displaying a user interface to a user, wherein the user interface presents a plurality of product package offers to the user, wherein the product package offers include at least a first product package and a second product package, wherein the first product package includes at least a first product content and a first advertisement content and the second product package includes at least the first product content, and wherein the first product package is offered for sale to the user at a first price and the second product package is offered for sale to the user at a second price, wherein the first price is different from the second price; and
means for inputting the user's selection of one of the plurality of product packages.

32. A system according to claim 31, further comprising:
means for receiving a final product package based on the user's selection.

33. A system according to claim 31, wherein the second product package further includes a second advertisement content, and wherein the second advertisement content is different from the first advertisement content.

34. A system according to claim 33, wherein the means for displaying further presents at least a third product package to the user, wherein the third product package includes at least the first product content, and wherein the third product package is offered for sale to the user at a third price, wherein the third price is different from the first price and the second price.

35. A system according to claim 34, wherein the third product package includes a third advertisement content, wherein the third advertisement content is different from the first advertisement content and the second advertisement content.

36. A method, comprising:
offering a product for sale, wherein the product includes a product content and at least one advertisement slot defined therein for potential insertion of advertisement content;
receiving a user's selection of a type or an amount of advertisement content desired along with the product; and
delivering a final product as directed by the user, wherein the final product includes the product content and the type or amount of advertisement content selected by the user, and wherein a final price of the final product depends, at least in part, on the type or amount of advertisement content selected by the user.

37. A method according to claim 36, further comprising:
offering the at least one advertisement slot to a plurality of potential advertisers.

38. A method according to claim 37, further comprising:
receiving at least one bid from the potential advertisers for the at least one advertisement slot, wherein the bid indicates an amount that the potential advertiser will pay to place an advertisement in at least one advertisement slot in the final product.

39. A method according to claim 38, further comprising:
awarding at least one advertisement slot to a potential advertiser that made a bid for the advertisement slot.

40. A method according to claim 39, further comprising:
including an advertisement in the final product from the potential advertiser to which the advertisement slot was awarded.

41. A method according to claim 39, further comprising:
including a link in the final product to an advertisement from the potential advertiser to which the advertisement slot was awarded, wherein the advertisement is displayed as the final product is being used by or delivered as directed by the user.

42. A method according to claim 39, further comprising:
displaying an advertisement from the potential advertiser to which the advertisement slot was awarded simultaneously with at least a portion of the product content.

43. A method according to claim 39, further comprising:
displaying an advertisement from the potential advertiser to which the advertisement slot was awarded during a time period when the final product is being downloaded.

44. A method according to claim 39, wherein delivering the final product includes sequentially delivering a first portion of the product content, delivering an advertisement from the potential advertiser to which the advertisement slot was awarded, and delivering a second portion of the product content.

45. A method according to claim 36, wherein the final product includes advertisement content from at least one advertising party, wherein the at least one advertising party can change the advertisement content at any time at least until the final product is delivered as directed by the user.

46. A method according to claim 45, wherein the advertisement content is included in the final product by including a link in the final product which calls up an advertisement of the at least one advertising party.

47. A method according to claim 46, wherein the link in the final product links to an internet address specified by the at least one advertising party.

48. A method according to claim 36, wherein the final product includes advertisement content from at least a first advertising party and a second advertising party, wherein the first advertising party can change its advertisement content at any time at least until the final product is delivered as directed by the user, and wherein the second advertising party can change its advertisement content at any time at least until the final product is delivered as directed by the user.

49. A method according to claim 36, further comprising:
including the advertisement content from a first advertising party in the final product, wherein the advertisement content from the first advertising party modifies the product content.

50. A system, comprising:
means for offering a product for sale, wherein the product includes a product content and at least one advertisement slot defined therein for potential insertion of advertisement content;
means for receiving a user's selection of a type or an amount of advertisement content desired along with the product; and
means for delivering a final product as directed by the user, wherein the final product includes the product content and the type or amount of advertisement content selected by the user, and wherein a final price of the final product depends, at least in part, on the type or amount of advertisement content selected by the user.

51. A system according to claim 50, further comprising:
means for offering the at least one advertisement slot to a plurality of potential advertisers.

52. A system according to claim 51, further comprising:
means for receiving at least one bid from the potential advertisers for the at least one advertisement slot, wherein the bid indicates an amount that the potential advertiser will pay to place an advertisement in at least one advertisement slot in the final product.

53. A system according to claim 52, further comprising:
means for inserting an advertisement in the final product from a potential advertiser to which the advertisement slot was awarded.

54. A system according to claim 53, wherein the advertisement in the final product includes a link to an advertisement from the potential advertiser to which the advertisement slot was awarded.

55. A system according to claim 52, further comprising:
means for displaying an advertisement from a potential advertiser to which the advertisement slot was awarded simultaneously with at least a portion of the product content.

56. A system according to claim 52, further comprising:
means for displaying an advertisement from a potential advertiser to which the advertisement slot was awarded during a time period when the final product is being downloaded.

57. A system according to claim 52, wherein the means for delivering the final product sequentially delivers a first portion of the product content, an advertisement from a potential advertiser to which the advertisement slot was awarded, and a second portion of the product content.

58. A system according to claim 50, wherein the final product includes advertisement content from at least one advertising party, wherein the at least one advertising party can change the advertisement content at any time at least until the final product is delivered as directed by the user.

59. A system according to claim 50, wherein the final product includes advertisement content from at least a first advertising party and a second advertising party, wherein the first advertising party can change its advertisement content at any time at least until the final product is delivered as directed by the user, and wherein the second advertising party can change its advertisement content at any time at least until the final product is delivered as directed by the user.

60. A system according to claim 52, further comprising:
means for modifying the product content based on the advertisement content of a potential advertiser to which the advertisement slot was awarded.

61. A method, comprising:
offering a product for sale, wherein the product includes a product content and at least one advertisement slot defined therein for potential insertion of advertisement content;
receiving an order from a user for a final product;
determining a number of available advertisement slots in the final product ordered by the user;
offering the available advertisement slots in the final product to a plurality of potential advertisers;
receiving bids from the potential advertisers for the available advertisement slots;
selecting one or more actual advertiser for the final product based at least in part on the bids received from the potential advertisers; and
delivering the final product as directed by the user, wherein the final product includes the product content and advertisement content from the one or more actual advertisers.

62. A method according to claim 61, wherein the order from the user dictates the number of available advertisement slots.

63. A method according to claim 61, wherein offering the available advertisement slots in the final product to the potential advertisers includes providing information about the user that ordered the product.

64. A method according to claim 61, further comprising:
obtaining the advertisement content from at least one of the actual advertisers immediately before delivering the final product as directed by the user.

65. A method according to claim 61, further comprising:
including a link in the final product to a linked advertisement from at least one of the actual advertisers, wherein the linked advertisement is displayed as the final product is being used by or delivered as directed by the user.

66. A method according to claim 65, wherein the linked advertisement in the final product links the user to an internet address specified by the actual advertiser that provides the linked advertisement.

67. A method according to claim 61, further comprising:
modifying the product content based on at least one of the actual advertisers selected.

68. A system, comprising:
means for offering a product for sale, wherein the product includes a product content and at least one advertisement slot defined therein for potential insertion of advertisement content;
means for receiving an order from a user for a final product;
means for determining a number of available advertisement slots in the final product ordered by the user;
means for offering the available advertisement slots in the final product to a plurality of potential advertisers; means for receiving bids from the potential advertisers for the available advertisement slots;
means for selecting one or more actual advertiser for the final product based at least in part on the bids received from the potential advertisers; and
means for delivering the final product as directed by the user, wherein the final product includes the product content and advertisement content from the one or more actual advertisers.

69. A system according to claim 68, wherein the order from the user dictates the number of available advertisement slots.

70. A system according to claim 68, wherein the means for offering the available advertisement slots in the final product includes providing information about the user that ordered the product.

71. A system according to claim 68, further comprising:
means for obtaining the advertisement content from at least one of the actual advertisers immediately before delivering the final product as directed by the user.

72. A system according to claim 68, further comprising:
means for inserting a link in the final product to a linked advertisement from at least one of the actual advertisers, wherein the linked advertisement is displayed as the final product is being used by or delivered as directed by the user.

73. A system according to claim 72, wherein the linked advertisement in the final product links the user to an internet address specified by the actual advertiser that provides the linked advertisement.

74. A method according to claim 68, further comprising:
means for modifying the product content based on at least one of the actual advertisers selected.

75. A method, comprising:
offering a product for sale, wherein the product includes a product content and at least one advertisement slot defined therein for potential insertion of advertisement content;
offering potentially available advertisement slots to a plurality of potential advertisers;
receiving bids from the potential advertisers for the potentially available advertisement slots;
receiving an order from a user for a final product, wherein the final product ordered dictates a number of advertisement slots to be included in the final product;
selecting one or more actual advertiser for the final product based at least in part on the bids received from the potential advertisers; and
delivering the final product as directed by the user, wherein the final product includes the product content and advertisement content from the one or more actual advertisers.

76. A method according to claim 75, further comprising:
obtaining the advertisement content from at least one of the actual advertisers immediately before delivering the final product as directed by the user.

77. A method according to claim 75, further comprising:
including a link in the final product to a linked advertisement from at least one of the actual advertisers, wherein the linked advertisement is displayed as the final product is being used by or delivered as directed by the user.

78. A method according to claim 77, wherein the linked advertisement in the final product links the user to an internet address specified by the actual advertiser that provides the linked advertisement.

79. A method according to claim 75, further comprising:
modifying the product content based on at least one of the actual advertisers selected.

80. A system, comprising:
means for offering a product for sale, wherein the product includes a product content and at least one advertisement slot defined therein for potential insertion of advertisement content;
means for offering potentially available advertisement slots to a plurality of potential advertisers;
means for receiving bids from the potential advertisers for the potentially available advertisement slots;
means for receiving an order from a user for a final product, wherein the final product ordered dictates a number of advertisement slots to be included in the final product;
means for selecting one or more actual advertiser for the final product based at least in part on the bids received from the potential advertisers; and
means for delivering the final product as directed by the user, wherein the final product includes the product content and advertisement content from the one or more actual advertisers.

81. A system according to claim 80, further comprising:
means for obtaining the advertisement content from at least one of the actual advertisers immediately before delivering the final product as directed by the user.

82. A system according to claim 80, further comprising:
means for inserting a link in the final product to a linked advertisement from at least one of the actual advertisers, wherein the linked advertisement is displayed as the final product is being used by or delivered as directed by the user.

83. A system according to claim 82, wherein the linked advertisement in the final product links the user to an internet address specified by the actual advertiser that provides the linked advertisement.

84. A system according to claim 80, further comprising:
means for modifying the product content based on at least one of the actual advertisers selected.
